(19) United States
(12) Patent Application Publication
(10) Pub. No.: US 2026/0229563 A1
(43) Pub. Date: Aug. 6, 2026

(54) ELECTROCHEMICAL CELL SYSTEMS INCLUDING PARTICULATE THERMAL STORAGE MATERIAL

(71) Applicant: Bloom Energy Corporation, San Jose, CA (US)

(72) Inventors: Pratik K. MARATHE, Mumbai (IN); Purushothaman JAGANATHAN, Mumbai (IN)

(21) Appl. No.: 19/456,347

(22) Filed: Jan. 22, 2026

Related U.S. Application Data
(60) Provisional application No. 63/753,542, filed on Feb. 4, 2025.

(51) Int. Cl. H01M 8/04701; H01M 8/04082; H01M 8/04791; H01M 8/2465

(52) U.S. Cl. CPC H01M 8/04716; H01M 8/04201; H01M 8/04708; H01M 8/04805; H01M 8/2465

(57) ABSTRACT

A method includes providing an exhaust stream output from an electrochemical cell system to a particle bed of thermal storage material to heat the thermal storage material, and transferring heat from the thermal storage material to at least one fluid flowing through the thermal storage material.

### FIELD

The present disclosure is directed generally to electrochemical cell systems including a thermal storage device, and in particular, a thermal storage device including a particulate thermal storage material.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels.

### SUMMARY

According to various embodiments, a system includes an electrochemical cell system; a thermal storage device comprising a particle bed of thermal storage material; and an exhaust conduit fluidly connecting an outlet of the electrochemical cell system to the thermal storage device and configured to provide an exhaust stream output from the electrochemical cell system to the thermal storage material to heat the thermal storage material.

According to various embodiments, a method includes providing an exhaust stream output from an electrochemical cell system to a particle bed of thermal storage material to heat the thermal storage material, and transferring heat from the thermal storage material to at least one fluid flowing through the thermal storage material.

### BRIEF DESCRIPTION OF THE DRAWINGS

FIG. 1 is a perspective view of a modular fuel cell system according to various embodiments of the present disclosure.

FIG. 2A is top plan view of a modular fuel cell system according to various embodiments of the present disclosure.

FIG. 2B is a schematic block diagram illustrating components of a power module of the system of FIG. 2A according to various embodiments of the present disclosure.

FIG. 3 is a schematic view of a combined heat and power (CHP) system, according to an embodiment of the present disclosure.

FIG. 4 is a schematic view of an alternative thermal storage device, according to an alternative embodiment of the present disclosure.

FIG. 5 is a perspective view of an alternative modular fuel cell system according to various embodiments of the present disclosure.

### DETAILED DESCRIPTION

It is to be understood that both the foregoing general description and the following detailed description are exemplary and explanatory only and are not restrictive of the invention as claimed.

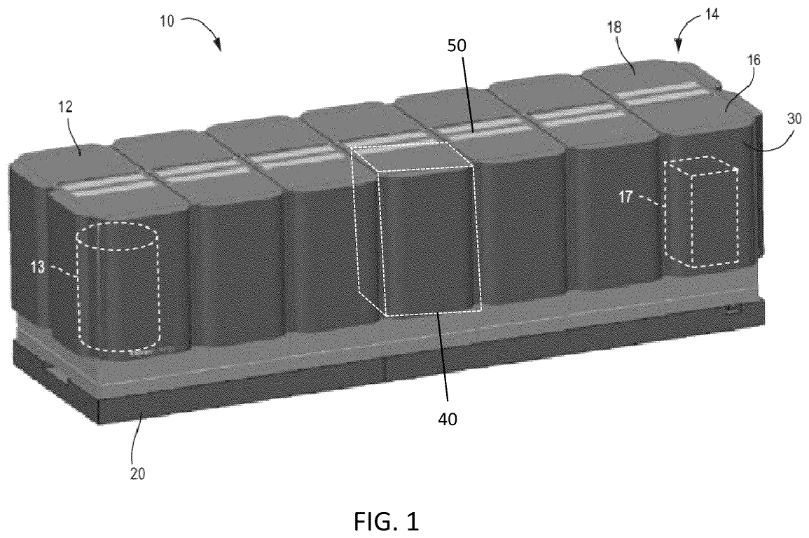

Referring to FIG. 1, a fuel cell power system 10 is shown according to an exemplary embodiment. The power system 10 may have a modular system layout. The power system 10 may contain modules and components described in U.S. Pat. No. 9,755,263 B2, issued on Sep. 5, 2017, which its incorporated herein by reference in its entirety. A modular design of the power system 10 may provide flexible system installation and operation. Modules allow scaling of installed generating capacity, reliable generation of power, flexibility of fuel processing, and flexibility of power output voltages and frequencies with a single design set. The modular design results in an “always on” unit with very high availability and reliability. This design also provides an easy means of scale up and meets specific requirements of customer installations. The modular design also allows the use of available fuels and required voltages and frequencies which may vary by customer and/or by geographic region. In other embodiments, the power system 10 may include a unitary system layout (also referred to as a “classic” system layout) rather than a modular system layout.

The power system 10 shown in FIG. 1 includes a housing 14 in which at least one power module 12 (preferably more than one or plurality of power modules 12), one or more fuel processing modules 16, and one or more power conditioning (i.e., electrical output) modules 18 are disposed. In embodiments, the power conditioning modules 18 are configured to deliver direct current (DC). In alternative embodiments, the power conditioning modules 18 are configured to deliver alternating current (AC). In these embodiments, the power conditioning modules 18 include a mechanism to convert DC to AC, such as an inverter. For example, the system 10 may include any desired number of modules, such as 2-30 power modules, for example 3-12 power modules, such as 6-12 modules.

The power system 10 of FIG. 1 includes twelve power modules 12 (two rows of six modules stacked side to side), one fuel processing module 16, and one power conditioning module 18 on a pad 20. In some embodiments, the pad 20 may be formed of a concrete or similar structural material that may be configured for permanent installation of the power system 10 at a site. In other embodiments described in further detail below, the power modules 12, fuel processing module 16 and power conditioning module 18 may be disposed on a skid having an upper surface (i.e., a deck) which rests upon pedestals (e.g., metal rails) that are connected to the deck. The skid may be configured to enable quick deployments and/or temporary deployments of the power system 10 and may reduce installation costs and cycle times.

The housing 14 may include a cabinet 40 to house each module 12, 16, 18. Alternatively, as will be described in more detail below, modules 16 and 18 may be disposed in a single cabinet 40. While two rows of power modules 12 are shown, the system may comprise a single row or more than two rows of modules 12.

Each power module 12 is configured to house one or more hot boxes 13. Each hot box contains one or more stacks or columns of fuel cells (not shown for clarity), such as one or more stacks or columns of solid oxide fuel cells having a ceramic oxide electrolyte separated by conductive interconnect plates. Other fuel cell types, such as PEM, molten carbonate, phosphoric acid, etc. may also be used.

The fuel cell stacks may comprise externally and/or internally manifolded stacks. For example, the stacks may be internally manifolded for fuel and air with fuel and air risers extending through openings in the fuel cell layers and/or in the interconnect plates between the fuel cells.

Alternatively, the fuel cell stacks may be internally manifolded for fuel and externally manifolded for air, where only the fuel inlet and exhaust risers extend through openings in the fuel cell layers and/or in the interconnect plates between the fuel cells, as described in U.S. Pat. No. 7,713,649, which is incorporated herein by reference in its entirety. The fuel cells may have a cross flow (where air and fuel flow roughly perpendicular to each other on opposite sides of the electrolyte in each fuel cell), counter flow parallel (where air and fuel flow roughly parallel to each other but in opposite directions on opposite sides of the electrolyte in each fuel cell) or co-flow parallel (where air and fuel flow roughly parallel to each other in the same direction on opposite sides of the electrolyte in each fuel cell) configuration.

The power system 10 also contains at least one fuel processing module 16. The fuel processing module 16 includes components for pre-processing of fuel, such as adsorption beds (e.g., desulfurizer and/or other impurity adsorption) beds. The fuel processing module 16 may be designed to process a particular type of fuel. For example, the system may include a diesel fuel processing module, a natural gas fuel processing module, and/or an ethanol fuel processing module, which may be provided in the same or in separate cabinets. A different bed composition tailored for a particular fuel may be provided in each module. The processing module(s) 16 may process at least one of the following fuels: natural gas provided from a pipeline, compressed natural gas, methane, propane, liquid petroleum gas, gasoline, diesel, home heating oil, kerosene, JP-5, JP-8, aviation fuel, hydrogen, ammonia, ethanol, methanol, syn-gas, bio-gas, bio-diesel and other suitable hydrocarbon or hydrogen containing fuels. If desired, the fuel processing module 16 may include a reformer 17. Alternatively, if it is desirable to thermally integrate the reformer 17 with the fuel cell stack(s), then a separate reformer 17 may be located in each hot box 13 in a respective power module 12. Furthermore, if internally reforming fuel cells are used, then an external reformer 17 may be omitted entirely.

The power conditioning module 18 includes components for converting the DC power generated by the fuel cell stacks to AC power (e.g., DC/DC and DC/AC converters described in U.S. Pat. No. 7,705,490, incorporated herein by reference in its entirety), electrical connectors for AC power output to the grid, circuits for managing electrical transients, and a system controller (e.g., a computer or dedicated control logic device or circuit). The power conditioning module 18 may be designed to convert DC power from the fuel cell modules to different AC voltages and frequencies. Designs for 208V, 60 Hz; 480V, 60 Hz; 415V, 50 Hz and other common voltages and frequencies may be provided.

The fuel processing module 16 and the power conditioning module 18 may be housed in one cabinet 40 of the housing 14. If a single input/output cabinet is provided, then modules 16 and 18 may be located vertically (e.g., power conditioning module 18 components above the fuel processing module 16 desulfurizer canisters/beds) or side by side in the cabinet.

As shown in one exemplary embodiment in FIG. 1, two rows of six power modules 12 are stacked back to back, where the power modules 12 in each row are arranged linearly side to side on one side of the input/output module 16/18. While two rows of power modules 12 are shown, the system 10 may comprise one row or more than two rows of modules 12. Each power module 12 may include a ventilation unit 50 disposed on the back side of the power module 12 cabinet 40.

The linear array of power modules 12 is readily scaled. For example, more or fewer power modules 12 may be provided depending on the power needs of the building or other facility serviced by the power system 10. The power modules 12 and input/output modules 16/18 may also be provided in other ratios. For example, in other exemplary embodiments, more or fewer power modules 12 may be provided adjacent to the input/output module 16/18. Further, the support functions could be served by more than one input/output module 16/18 (e.g., with a separate fuel processing module 16 and power conditioning module 18 cabinets). Additionally, while in the illustrated embodiment, the modules 16 and 18 are located at one end of the power module 12 rows, they could also be located in the center of a row power modules 12 or at opposite ends of different rows.

The power system 10 may be configured in a way to ease servicing of the components of the power system 10. All of the routinely or high serviced components (such as the consumable components) may be placed in a single module to reduce the amount of time required for the service person. For example, a purge gas (optional) and desulfurizer material for a natural gas fueled system may be placed in a single module (e.g., a fuel processing module 16 or a combined input/output module 16/18 cabinet 40). This would be the only module cabinet 40 accessed during routine maintenance. Thus, each module 12, 16, and 18 may be serviced, repaired or removed from the system without opening the other module cabinets and without servicing, repairing or removing the other modules.

For example, as described above, the power system 10 can include multiple power modules 12. When at least one power module 12 is taken off line (i.e., no power is generated by the stacks in the hot box 13 in the off line module 12), the remaining power modules 12, the fuel processing module 16 and the power conditioning module 18 (or the combined input/output module 16/18) are not taken off line. Furthermore, the power system 10 may contain more than one of each type of module 12, 16, or 18. When at least one module of a particular type is taken off line, the remaining modules of the same type are not taken off line.

Thus, in a system comprising a plurality of modules, each of the modules 12, 16, or 18 may be electrically disconnected, removed from the power system 10 and/or serviced or repaired without stopping an operation of the other modules in the system, allowing the fuel cell system to continue to generate electricity. The entire power system 10 does not have to be shut down if one stack of fuel cells in one hot box 13 malfunctions or is taken off line for servicing.

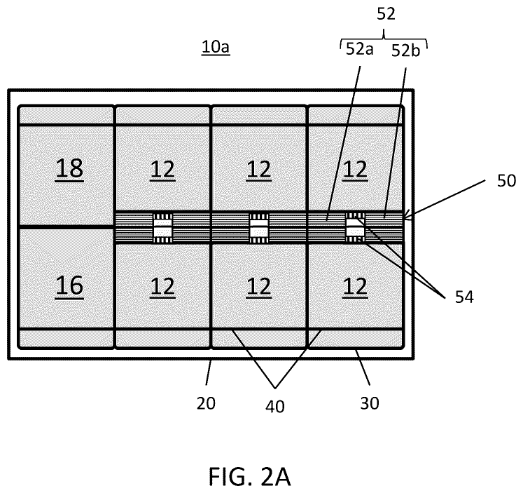

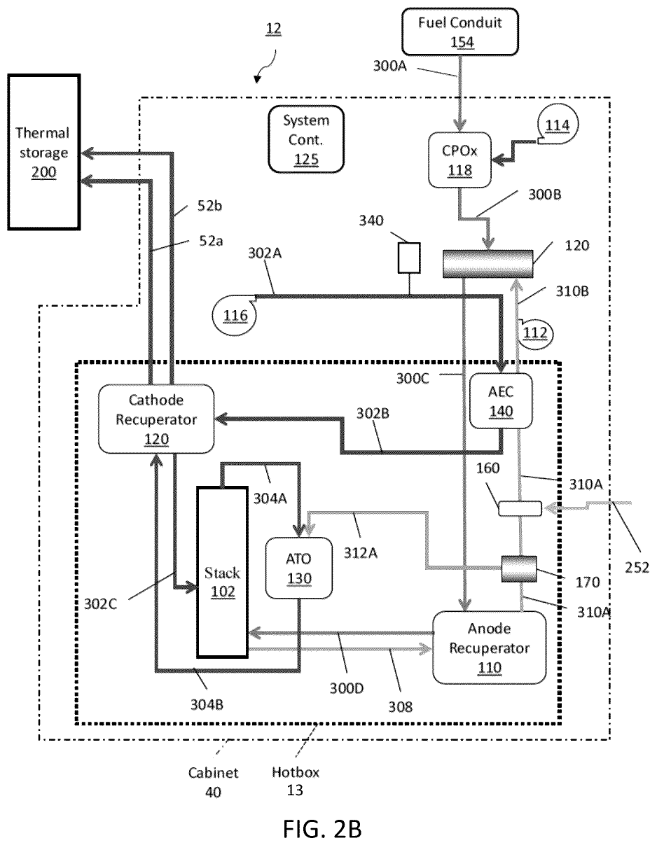

FIG. 2A illustrates top plan view of a fuel cell power system 10a according to various embodiments of the present disclosure. The power system 10a is similar to the power system 10 of FIG. 1. As such, similar reference numbers are used for similar elements, and only the differences therebetween will be described in detail.

Referring to FIG. 2A, the power system 10a includes power modules 12, a power conditioning module 18, and a fuel processing module 16 disposed on a base 20. The base 20 may comprise a concrete pad or a skid. The system 10a may include doors 30 to access the modules 12, 16, 18.

Each power module 12 may include a ventilation unit 50 disposed on the back side of the power module 12 cabinet 40, opposite the door 30. The ventilation units 50 may be configured to output a module exhaust through vents 52 and 54. The module exhaust may include a high temperature hotbox exhaust stream generated by fuel cell stacks or columns located in the hotboxes 13 output through first vents 52 and a lower temperature cabinet and electronics (e.g., DC-DC converter) air exhausted from module 12 cabinets 40 through second vents 54. The ventilation units 50 may include a fan (not shown) to facilitate the output of the module exhaust through the second vents 54.

The power modules 12 may be disposed in a back-to-back configuration. In particular, the power modules 12 may be disposed in parallel rows, and the fuel processing module 16 and the power conditioning module 18 may be disposed at ends of the rows. Accordingly, the power system 10a has an overall rectangular configuration.

While the system 10a is shown to include two rows of three power modules 12, the present disclosure is not limited to any particular number of power modules 12. For example, the system 10a may include 2-30 power modules 12, 4-12 power modules 12, or 6-12 power modules 12, in some embodiments. In other words, the power system 10a may include any desired number of power modules 12, with the power modules 12 being disposed in a back-to-back configuration or in a single row configuration. Alternatively, more than two rows may be provided in the system 10a. In addition, the positions of the fuel processing module 16 and the power conditioning module 18 may be reversed, and/or the modules 16, 18 may be disposed on either end of the system 10a or in the middle of rows of power modules 12.

FIG. 2B is a schematic block diagram illustrating components of an exemplary power module 12 according to various embodiments of the present disclosure. Referring to FIG. 2B, each power module 12 may include the module cabinet 40 containing the hotbox 13 and various components (e.g., balance of plant components) disposed in the cabinet 40 or adjacent thereto. The hotbox 13 may contain at least one fuel cell stack 102, such as a solid oxide fuel cell stack containing alternating fuel cells and interconnects. One solid oxide fuel cell of the stack contains a ceramic electrolyte, such as yttria stabilized zirconia (YSZ), scandia stabilized zirconia (SSZ), scandia and ceria stabilized zirconia or scandia, or yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects or stainless steel interconnects. The stacks 102 may be arranged over each other in a column. Alternatively, a column may contain only one stack 102. Plural columns may be located in each hot box 13.

The hotbox 13 may also contain an anode recuperator heat exchanger 110, a cathode recuperator heat exchanger 120, an anode tail gas oxidizer (ATO) 130, an anode exhaust cooler 140, an optional splitter 170, and a water injector 160. The power module 12 may also include an anode recycle blower 112. a CPOx blower 114 (e.g., CPOx air blower), a system blower 116 (e.g., main air blower), a catalytic partial oxidation (CPOx) reactor 118 and a mixer 120, which may all be disposed in the cabinet 40 outside of the hotbox 13. However, the present disclosure is not limited to any particular location for each of the components with respect to the hotbox 13.

The power module 12 may include an air conduit assembly 302 comprising air conduits 302A, 302B, and 302C that fluidly connect the system blower 116, the anode exhaust cooler 140, the cathode recuperator 120, and the stack 102. The power module 12 may also include an exhaust conduit assembly 304 comprising exhaust conduits 304A and 304B that fluidly connect the stack 102, the ATO 130, and the cathode recuperator 120.

The CPOx reactor 118 may receive a fuel inlet stream from a fuel source (e.g., system fuel inlet conduit or fuel storage device) 154 through fuel conduit 300A. The CPOx blower 114 may provide air to the CPOx reactor 118 during system start-up. The CPOx air blower 114 is turned off during system steady-state operation. The fuel and/or air may be provided to the mixer 120 by fuel conduit 300B. Fuel flows from the mixer 120 to the anode recuperator 110 through fuel conduit 300C. The fuel is heated in the anode recuperator 110 by the fuel exhaust (anode exhaust from stack 102 provided through conduit 308) and the fuel then flows from the anode recuperator 110 to the stack 102 through fuel conduit 300D.

The system blower 116 may be configured to provide an air stream (e.g., air inlet stream) to the anode exhaust cooler 140 through air conduit 302A. Air flows from the anode exhaust cooler 140 to the cathode recuperator 120 through air conduit 302B. The air is heated by the ATO exhaust in the cathode recuperator 120. The air flows from the cathode recuperator 120 to the stack 102 through air conduit 302C. The power module 12 may include a pressure sensor 340, such as a piezoresistive pressure sensor, configured to measure air pressure in air conduit 302A.

Anode exhaust (e.g., fuel exhaust) generated in the stack 102 is provided to the anode recuperator 110 through an anode exhaust conduit 308. The anode exhaust may contain unreacted fuel and may also be referred to herein as fuel exhaust. The anode exhaust may be provided from the anode recuperator 110 to the mixer 120 by a recycling conduit 310, which may include a first recycling conduit 310A and a second recycling conduit 310B. In particular, the first recycling conduit 310A may fluidly connect an outlet of the anode recuperator 110 to an inlet of the anode exhaust cooler 140. The second recycling conduit 310B may fluidly connect an outlet of the anode exhaust cooler 140 to an inlet of the mixer 120.

Water flows from a water source, such as a water tank or a water pipe, to the water injector 160 through a hotbox water conduit 252. Water treatment processes may be applied to water supplied to the hotbox water conduit 252 to remove impurities before supplying the water to the power module 12. The water injector 160 may be configured to inject water into anode exhaust flowing through the first recycling conduit 310A. Heat from the anode exhaust (also referred to as a recycled anode exhaust stream) vaporizes the water to generate steam which humidifies the anode exhaust. The humidified anode exhaust is provided to the anode exhaust cooler 140. Heat from the anode exhaust provided to the anode exhaust cooler 140 may be transferred to the air inlet stream provided from the system blower 116 to the cathode recuperator 120. The cooled humidified anode exhaust may then be provided from the anode exhaust cooler 140 to the mixer 120 via the second recycling conduit 310B. The anode recycle blower 112 may be configured to move the anode exhaust though the second recycling conduit 310B.

The mixer 120 is configured to mix the humidified anode exhaust with fresh fuel (i.e., fuel inlet stream). This humidified fuel mixture may then be heated in the anode recuperator 110 by the anode exhaust, before being provided to the stack 102. The power module 12 may also include one or more fuel reforming catalysts located inside and/or downstream of the anode recuperator 110. The reforming catalyst(s) reform the humidified fuel mixture before it is provided to the stack 102.

The splitter 170 may be operatively connected to the first recycling conduit 310A and may be configured to divert a portion of the anode exhaust to the ATO 130 via an ATO conduit 312A. The ATO conduit 312A may be fluidly connected directly to the ATO 130 or indirectly to the ATO 130 via the cathode exhaust conduit 304A.

Cathode exhaust (e.g., air exhaust) generated in the stack 102 is provided to the ATO 130 via the cathode exhaust conduit 304A. The cathode exhaust may be mixed with a portion of the anode exhaust before or after being provided to the ATO 130. The mixture of the anode exhaust and the cathode exhaust may be oxidized in the ATO 130. The oxidized cathode exhaust (i.e., ATO exhaust, which is also referred to as hotbox exhaust) flows from the ATO 130 to the cathode recuperator 120, through cathode exhaust conduit 304B. The hotbox exhaust stream flows from the cathode recuperator 120 and out of the hotbox 13 through at least one first vent 52. In one embodiment, the power module 12 may include a pair of first vents 52a, 52b in order to output the hotbox exhaust (which in some embodiments may be referred to as system exhaust, cathode exhaust or ATO exhaust) from the hotbox 13 rather than a single larger vent due to system size constraints. However, the present disclosure is not limited to any particular number of outlet conduits, and a single vent may be used instead. The vents 52a, 52b may be configured to provide the hotbox exhaust to a thermal storage device 200, as will be described in more detail below.

The power module 12 may further include a system controller 125 configured to control various elements of the power module 12. The controller 125 may include a central processing unit configured to execute stored instructions. For example, the controller 125 may be configured to control fuel and/or air flow through the power module 12, according to fuel composition data.

A fuel cell power system hotbox exhaust (e.g., module exhaust) may contain a significant amount of thermal energy. Heat recovered from the hotbox exhaust can be utilized for a number of beneficial applications. For example, combined heat and power fuel cell systems may provide both electrical power and heat to a site.

Fuel cell systems may suffer from operational issues in colder climates. For example, feed water may freeze and/or the operational life of desulfurization catalysts may be reduced when operated at cooler temperatures. The hotbox exhaust heat may be used to heat the feed water in the hotbox water conduit 252. Furthermore, the hotbox exhaust heat may also be used to heat the fuel inlet stream provided to the fuel processing module 16.

Metal heat exchangers may be used to transfer heat from one medium to another, such as from hotbox exhaust to water. However, metal heat exchangers may be costly and may require periodic maintenance. In addition, metal heat exchanges cannot provide long term heat storage. The present inventors determined that particle beds may provide a more cost effective and efficient form of heat recovery and storage when combined with the electrochemical cell system hotbox exhaust.

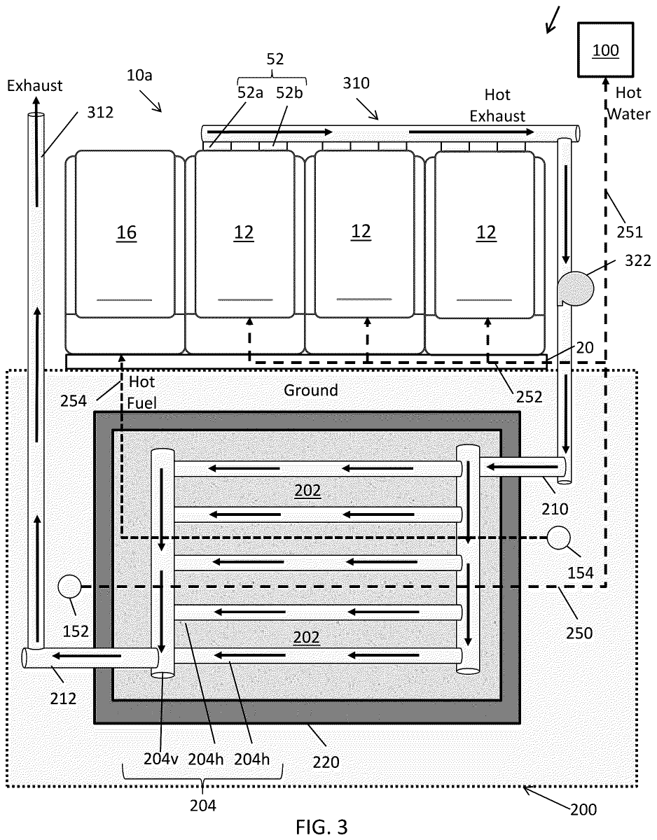

FIG. 3 is a schematic view of a combined heat and power (CHP) system 300, according to various embodiments of the present disclosure. Referring to FIGS. 1, 2A, 2B and 3, the CHP system 300 may include the fuel cell power system 10 or 10a, an exhaust conduit 310, which may comprise a pipe, header or manifold, an exhaust outlet conduit 312, and the thermal storage device 200. The thermal storage device 200 may include a particulate thermal storage material 202, at least one optional heat transfer conduit 204 (e.g., pipe, header or manifold), a storage inlet 210, a storage outlet 212, and an optional thermally insulated container 220. The exhaust conduit 310 is fluidly connected to the storage inlet 210 of the thermal storage device 200, and the exhaust outlet conduit 312 is fluidly connected to the storage outlet 212 of the thermal storage device 200.

In one embodiment, the thermal storage device 200 may be buried under ground, as shown in FIG. 3 and the container 220 may be optionally omitted. In an alternative embodiment, the thermal storage device 200 may be disposed above ground and may include the container 220.

The exhaust conduit 310 may provide the hotbox exhaust from plural power modules 12 to the thermal storage device 200. For example, the exhaust conduit 310 may fluidly connect the first vents 52 of each power module 12 to the storage inlet 210. In some embodiments, an optional fan or blower 322 may be disposed on the exhaust conduit 310 and may be configured to compensate for a pressure drop caused by the hotbox exhaust flowing through the thermal storage device 200. The optional fan or blower 322 may be enclosed in the housing of the system 10 or 10a (e.g., in one of the cabinets 40). The exhaust outlet conduit 312 may be fluidly connected to the storage outlet 212 and may be configured to receive cooled hotbox exhaust from the storage outlet 212 and then release the cooled hotbox exhaust to the atmosphere.

The thermal storage material 202 may be a particulate material that can efficiently absorb and release thermal energy. For example, the thermal storage material 202 may include a particulate material, such gravel (e.g., basalt and/or quartz gravel), sand (e.g., silica and/or calcia sand), small stones, or the like. The thermal storage material 202 may be in the form of a packed particle bed and may include a locally sourced particulate material to reduce system costs. In various embodiments, the thermal storage material 202 may have an average particle size ranging from about 0.2 mm to about 20 mm, such as from about 0.5 mm to about 4 mm, or from about 1 mm to about 2 mm. The average particle size may depend on the particulate material utilized. For example, silica sand may have an average particle size ranging from about 1.5 mm to about 2.5 mm, basalt gravel may have an average particle size ranging from about 2 mm to about 4 mm, and quartz gravel may have an average particle size ranging from about 1 mm to about 2 mm. In alternative embodiments, the thermal storage material may comprise a phase change material, such as paraffins or salt hydrates.

The heat transfer conduit 204 may extend through the storage material 202 and may fluidly connect the storage inlet 210 to the storage outlet 212. Accordingly, the power module 12 hotbox exhaust may flow from the power modules 12, through the exhaust conduit 310, the storage inlet 210, the heat transfer conduit 204, the storage outlet 212, and the exhaust outlet conduit 312, before being exhausted to the atmosphere. The heat transfer conduit 204 may be formed of a material having a high thermal conductivity, in order to efficiently transfer heat from the hotbox exhaust to the thermal storage material 202. For example, the heat transfer conduit 204 may be formed of a metal, such as stainless steel, aluminum or nickel—chromium alloy (e.g., Inconel family of alloys). In one embodiment, the heat transfer conduit 204 may extend in a vertical direction and may comprise vertical heat transfer conduit portions 204v and horizontal heat transfer conduit portions 204h that extend between the vertical conduit portions 204v. The conduits 204v, 204h may have a regular spacing, in order to evenly transfer heat to the storage material 202. However, any suitable conduit configuration may be used. For example, the heat transfer conduit 204 may extend horizontally instead of or in addition to extending vertically, and may include conduit portions extending in a different directions in a horizontal plane or in a three dimensional volume. Alternatively, the heat transfer conduit 204 may be a single conduit having a serpentine configuration, which extends in any suitable direction, such as vertical, horizontal or any in between directions.

The system 300 may also include a water conduit 250 (e.g., pipe, header or manifold) that extends through the storage material 202 and fluidly connects a water source (e.g., a municipal water pipe or a water storage tank) 152 to a user site 100, such as a building (e.g., a residential building or an industrial building) or the like, and/or to the power modules 12. In one embodiment, the water conduit 250 may include a site water conduit 251 branch which fluidly connects the water source 152 to the user site 100, and a hotbox water conduit 252 branch which fluidly connects the water source 152 to the water injectors 160 in each hotbox 13. The hotbox water conduit 252 may extend through the base 20 to each power module 12.

The system 300 may also include a fuel conduit 254 that extends through the storage material 202 to fluidly connect a fuel source 154 (e.g., a fuel conduit, such as a natural gas pipe, or fuel storage device, such as a gas tank) to a fuel processing module 16. The conduits 250, 254 may be formed of a material having high thermal conductivity. For example, the conduits 250, 254 may be formed of a metal such as stainless steel, aluminum, or the like. The conduits 250, 254 may be single conduits or may be multiple fluidly connected conduits.

Heat transferred from the hotbox exhaust to the storage material 202 may be transferred from the storage material 202 to heat at least one of water or fuel. In one embodiment, the heat from the storage material 202 may be transferred through the water conduit 250 and the site water conduit 251 branch of the water conduit 250 to heat water flowing from the water source 152 through the water conduit 250. As such, hot water may be provided to the user site 100. In another embodiment, hot water may also be provided from the water conduit 250 and the hotbox water conduit 252 branch to the water injectors 160 located in the power modules 12 of power system 10 or 10a. In yet another embodiment, hot water is provided to both the water injectors 160 and the user site 100.

In another embodiment, heat may also be transferred from the storage material 202 through the fuel conduit 254 to heat fuel flowing through the fuel conduit 254 from a fuel source 154 to a fuel processing module 16. Increasing the temperature of the fuel may increase the lifespan and/or reaction rate of desulfurization catalysts included in a fuel processing module 16. For example, the present inventors determined that heating fuel to a temperature of at least 70° C. may increase a lifespan of a catalyst by over 5%. As such, the fuel may be heated to a temperature of at least 70° C., such as a temperature ranging from 70° C. to 100° C., during steady state operation of the fuel cell power system 10 or 10a. In another embodiment, heat from the storage material 202 may be transferred to heat both the water and the fuel.

At a given hotbox exhaust flow rate, the temperature of a fluid (e.g., water and/or fuel) heated by the thermal storage device 200 may be controlled by controlling a residence time (e.g., a heat transfer time) of the fluid in the thermal storage device 200. Residence time may be determined based on conduit 204 length and/or fluid flow rate. For example, a higher flow rate and/or a shorter conduit 204 length may result in a lower fluid temperature, while a lower flow rate and/or a longer conduit length may result in a higher fluid temperature.

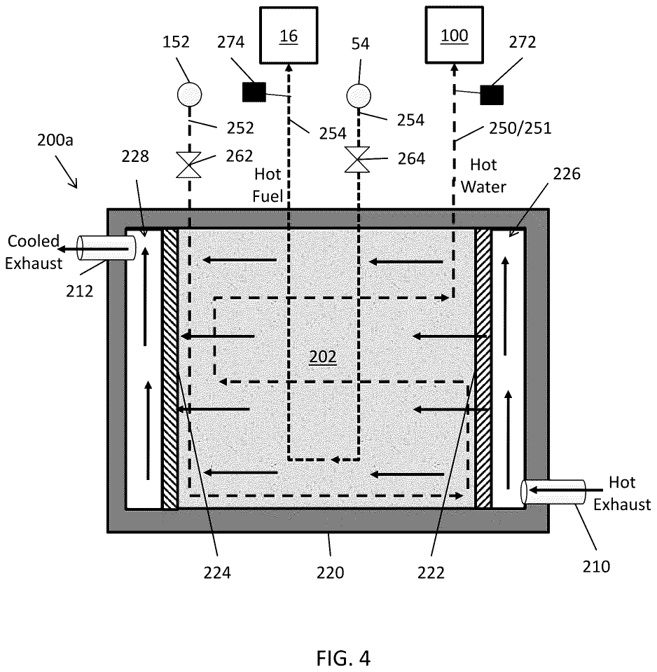

FIG. 4 is a schematic view of an alternative thermal storage device 200a, according to an alternative embodiment of the present disclosure. The thermal storage device 200a may be similar to the thermal storage device 200 of FIG. 3. As such, only the differences therebetween will be discussed in detail. Specifically, the heat transfer conduit 204 is omitted in the embodiment of FIG. 4.

Referring to FIG. 4, the thermal storage device 200a may include first and second holders 222, 224 disposed on opposite sides of the storage material 202. The holders 222, 224 may be perforated structures, such as screens or slotted metal sheets configured to permit fluid (i.e., hotbox exhaust gas) flow therethrough, while holding the storage material 202 in place. Thus, the openings in the holders may have a diameter that is smaller than the particle size of the particulate storage material 202. The holders 222, 224 may at least partially define an inlet chamber 226 and an outlet chamber 228 on opposite sides of the storage material 202.

Hotbox exhaust provided to the storage inlet 210 may be dispersed in the inlet chamber 226. The dispersed hotbox exhaust may pass through the first holder 222 and interact with the storage material 202. The hotbox exhaust may heat the storage material 202 while flowing through gaps between particles of the storage material 202. The hotbox exhaust may then pass through the second holder 224, be collected in the outlet chamber 228, and then be output through to the storage outlet 212.

The water conduit 250 and the fuel conduit 254 may extend through the storage material 202. In some embodiments, the water conduit 250 may be longer than the fuel conduit 254. For example, the water conduit 250 may have a serpentine configuration and the fuel conduit 254 may have a U-shaped structure. As such, water flowing through the water conduit 250 may be heated to a higher temperature than the fuel flowing through the fuel conduit 254. However, in other embodiments, the fuel conduit 254 may be longer than the water conduit 250 in order to provide a higher temperature fuel, or the conduits 250, 254 may have equal lengths.

In some embodiments, the thermal storage device 200a may include a first valve 262 and a first temperature sensor 272 disposed on the water conduit 250, and a second valve 264 and a second temperature sensor 274 disposed on the fuel conduit 254. The valves 262, 264 may be proportional valves. The first valve 262 may be configured to control the water flow rate through the water conduit 250 based on a water temperature determined by the first temperature sensor 272. The second valve 264 may be configured to control a fuel flow rate based on a fuel temperature determined by the second temperature sensor 274.

According to various embodiments, elements of the thermal storage device 200a may be included in the thermal storage device 200. For example, the thermal storage device 200 may include valves 262, 264 and temperature sensors 272, 274.

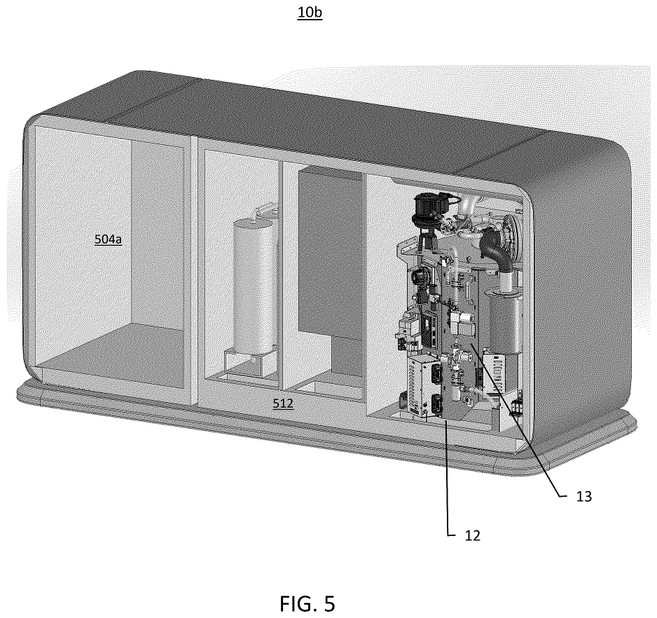

FIG. 5 is a perspective view of an alternative modular fuel cell power system according to various embodiments of the present disclosure. In particular, fuel cell power system 10b may be more suitable for residential installations. Fuel cell power system 10b comprises three cabinet compartments: one compartment 504a which can be utilized for housing a battery, compartment 512 which is similar to combined input/output module 16/18 of system 10, and one power module 12 comprising a hotbox 13. Fuel cell power system 10b may be configured with thermal storage device 200 in the same manner as systems 10 and 10a for use in providing hot water or other heating applications associated with single-family dwellings, or to heat gas and water supplied to compartment 512 as illustrated in FIGS. 3 and 4.

While the embodiments describe solid oxide fuel cell power systems as examples of electrochemical cell systems, the present disclosure is not limited to such systems. The electrochemical cell systems of the present disclosure may also include electrolyzer cell systems, such as solid oxide electrolyzer cell systems, and other fuel cell and electrolyzer cell systems which generate a hot system exhaust (e.g., hotbox exhaust).

Fuel cell and electrolyzer cell systems of the embodiments of the present disclosure are designed to reduce greenhouse gas emissions and have a positive impact on the climate.

The arrangements of the electrochemical cell system and/or thermal storage device, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, orientations, etc.) without materially departing from the novel teachings and advantages of the subject matter described herein.

Some elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present disclosure. Any one or more features of any embodiment may be used in any combination with any one or more other features of one or more other embodiments.

1. A system, comprising:
an electrochemical cell system;
a thermal storage device comprising a particle bed of thermal storage material; and
an exhaust conduit fluidly connecting an outlet of the electrochemical cell system to the thermal storage device and configured to provide an exhaust stream output from the electrochemical cell system to the thermal storage material to heat the thermal storage material.

2. The system of claim 1, wherein:
the electrochemical cell system comprises a fuel cell power system comprising one or more power modules and a fuel processing module; and
the exhaust conduit fluidly connects the one or more power modules to the thermal storage device.

3. The system of claim 2, wherein each of the one or more power modules comprises:
a respective hotbox housing at least one fuel cell stack and an anode tail gas oxidizer configured to oxidize at least a portion of an anode exhaust stream from the at least one fuel cell stack using at least a portion of a cathode exhaust stream from the at least one fuel cell stack to generate the exhaust stream; and
at least one vent fluidly connecting the hotbox to the exhaust conduit and configured to provide the exhaust stream to the exhaust conduit.

4. The system of claim 1, wherein the thermal storage device comprises at least one heat transfer conduit that extends through the thermal storage material and is fluidly connected to the exhaust conduit.

5. The system of claim 4, wherein the at least one heat transfer conduit comprises a plurality of fluidly connected heat transfer conduits.

6. The system of claim 4, wherein the at least one heat transfer conduit comprises a serpentine heat transfer conduit.

7. The system of claim 1, wherein the thermal storage device is disposed below ground and the electrochemical cell system is disposed above ground.

8. The system of claim 1, wherein:
the thermal storage device comprises a thermally insulated container in which the thermal storage material is disposed; and
the thermal storage device and the electrochemical cell system are disposed above ground.

9. The system of claim 1, further comprising a water conduit extending through the thermal storage device and fluidly connecting a water source to at least one of the electrochemical cell system or a building, wherein the water conduit is configured to transfer heat from the thermal storage material to water flowing through the water conduit.

10. The system of claim 2, further comprising a fuel conduit extending through the thermal storage device and fluidly connecting a fuel source to the fuel processing module, and configured to transfer heat from the thermal storage material to fuel flowing through the fuel conduit.

11. The system of claim 1, wherein the thermal storage device comprises:
a thermally insulated container in which the thermal storage material is disposed;
perforated first and second holders disposed on opposing sides of the thermal storage material.

12. The system of claim 11, wherein the thermal storage device further comprises:
an inlet chamber that is at least partially defined by the first holder;
an outlet chamber that is at least partially defined by the first holder;
a storage inlet configured to fluidly connect the inlet chamber to the exhaust conduit; and
a storage outlet configured to fluidly connect the outlet chamber to an outlet exhaust conduit.

13. The system of claim 12, wherein the thermal storage material comprises a particulate material that is configured to allow the exhaust stream to flow therethrough.

14. The system of claim 1, wherein the thermal storage material comprises at least one of rocks, gravel, sand, or a phase change material.

15. The system of claim 14, wherein the thermal storage material comprises at least one of the rocks, gravel or sand, and has an average particle size ranging from about 0.2 mm to about 20 mm.

16. A method, comprising:
providing an exhaust stream output from an electrochemical cell system to a particle bed of thermal storage material to heat the thermal storage material; and
transferring heat from the thermal storage material to at least one fluid flowing through the thermal storage material.

17. The method of claim 16, wherein:
the electrochemical cell system comprises a fuel cell power system comprising one or more power modules and a fuel processing module;
each of the one or more power modules comprises a respective hotbox housing at least one fuel cell stack and an anode tail gas oxidizer;
at least a portion of an anode exhaust stream from the at least one fuel cell stack is oxidized in the anode tail gas oxidizer using at least a portion of a cathode exhaust stream from the at least one fuel cell stack to generate the exhaust stream; and
the exhaust conduit is provided from the anode tail gas oxidizer to the thermal storage material.

18. The method of claim 17, wherein the fluid comprises water that is provided to at least one of water injectors located in the one or more power modules or to a building.

19. The method of claim 17, wherein the fluid comprises fuel that is provided into the fuel processing module.

20. The method claim 16, wherein the thermal storage material comprises at least one of rocks, gravel, sand, or a phase change material.
